(19) United States
(12) Patent Application Publication
(10) Pub. No.: US 2023/0127170 A1
(43) Pub. Date: Apr. 27, 2023

(54) SUSPENSION ASSEMBLY AND DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Hiroyuki Hyodo, Yokohama (JP)

(21) Appl. No.: 17/817,509

(22) Filed: Aug. 4, 2022

(30) Foreign Application Priority Data
Oct. 26, 2021 (JP) 2021-174808

(51) Int. Cl. G11B 5/48

(52) U.S. Cl. CPC G11B 5/4833

(57) ABSTRACT

According to one embodiment, a head suspension assembly includes a base plate including a first main surface and a through-hole penetrating the first main surface, a load beam including a base end portion fixed to the base plate and extending from the base plate, a wiring member provided on the first main surface of the base plate and the load beam, and a magnetic head placed on the wiring member. The base plate includes a partition recess formed on the first main surface and continuously or intermittently extending to partition the magnetic head and the through-hole.

### CROSS-REFERENCE TO RELATED APPLICATIONS

This application is based upon and claims the benefit of priority from Japanese Patent Application No. 2021-174808, filed Oct. 26, 2021, the entire contents of which are incorporated herein by reference.

### FIELD

Embodiments described herein relate generally to a head suspension assembly and a magnetic disk device.

### BACKGROUND

As the magnetic disk device, for example, a hard disk drive (HDD) includes a plurality of magnetic disks rotatably arranged in a housing, a plurality of magnetic heads for reading and writing information on the magnetic disks, and a head actuator for movably supporting the magnetic heads with respect to the magnetic disks.

The head actuator includes an actuator block rotatably supported, and a plurality of head suspension assemblies (may be referred to as head gimbal assemblies) respectively extending from the actuator block and supporting the magnetic head at their tip portions. The head suspension assembly includes a base plate having one end fixed to an arm, a load beam extending from the base plate, a tab extending from a tip of the load beam, and a flexure (wiring member) provided on the load beam and the base plate. The flexure includes a displaceable gimbal portion, and the magnetic head is supported by the gimbal portion.

As a method for fixing the base plate to the arm, a method has been proposed in which a metal ball is pushed through a through-hole formed in the base plate and the arm, and a part of the base plate is crimped to fix the base plate to the arm.

### BRIEF DESCRIPTION OF THE DRAWINGS

FIG. 1 is an exploded perspective view illustrating a base and a top cover of a hard disk drive (HDD) according to a first embodiment.

FIG. 2 is a perspective view illustrating a head actuator assembly and an FPC unit of the HDD.

FIG. 3 is a perspective view illustrating a head suspension assembly of the head actuator assembly.

FIG. 4 is a partial sectional view of a base plate of the head suspension assembly taken along line A-A of FIG. 3.

FIG. 5 is an exploded perspective view illustrating an up-head suspension assembly, an arm, and a down-head suspension assembly.

FIG. 6 is a perspective view illustrating the head suspension assembly according to a second embodiment.

FIG. 7 is a sectional view of a flexure taken along line B-B of FIG. 6.

FIG. 8 is a perspective view illustrating the head suspension assembly according to a third embodiment.

FIG. 9 is a perspective view illustrating the head suspension assembly according to a fourth embodiment.

FIG. 10 is a perspective view illustrating the head suspension assembly according to a fifth embodiment.

FIG. 11 is a perspective view illustrating the head suspension assembly according to a sixth embodiment.

### DETAILED DESCRIPTION

Various embodiments will be described hereinafter with reference to the accompanying drawings. In general, according to one embodiment, a head suspension assembly comprises a base plate including a first main surface and a through-hole penetrating the first main surface; a load beam including a base end portion fixed to the base plate and extending from the base plate; a wiring member provided on the first main surface of the base plate and the load beam, and including a gimbal portion facing an extending end portion of the load beam; and a magnetic head placed on the gimbal portion. The base plate includes a partition recess formed on the first main surface and continuously or intermittently extending to partition the magnetic head and the through-hole.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

### First Embodiment

A hard disk drive (HDD) according to a first embodiment will be described in detail as a magnetic disk device.

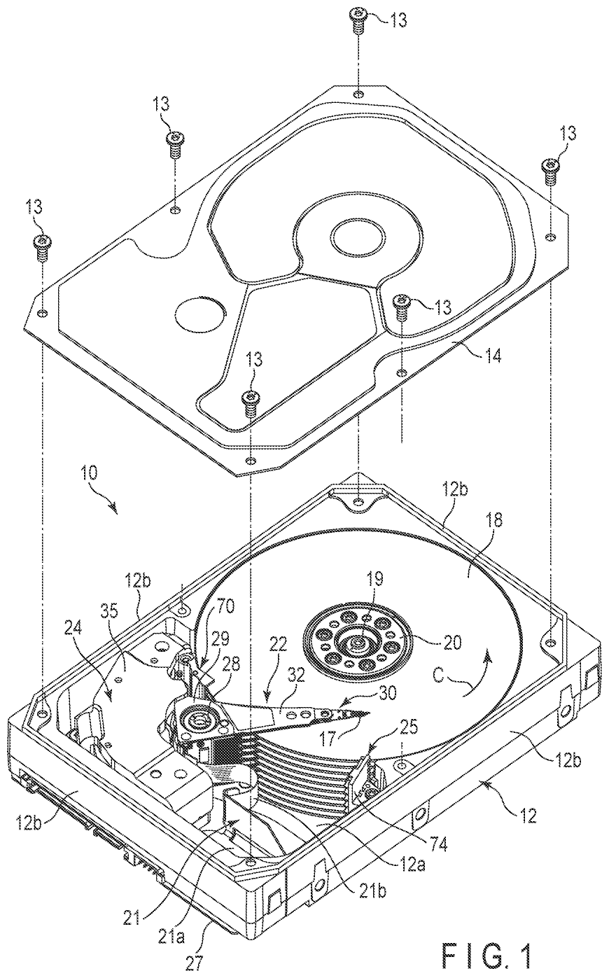

FIG. 1 is an exploded perspective view of an HDD according to an embodiment illustrated with a cover removed.

As illustrated in FIG. 1, the HDD comprises a rectangular housing 10. The housing 10 includes a rectangular box-shaped base 12 having an upper opening, and a cover (top cover) 14. The base 12 has a rectangular bottom wall 12a, and side walls 12b erected along a peripheral edge of the bottom wall 12a, and is integrally formed of aluminum, for example. The cover 14 is made of, for example, stainless steel and formed in a rectangular plate shape. The cover 14 is screwed onto the side walls 12b of the base 12 by a plurality of screws 13 to hermetically close the upper opening of the base 12.

In the housing 10, a plurality of, for example, 10 magnetic disks 18 as disk-shaped recording media, and a spindle motor 19 that supports and rotates the magnetic disks 18 are provided. The spindle motor 19 is disposed on the bottom wall 12a. Each magnetic disk 18 includes, for example, a substrate made of a non-magnetic material such as glass formed in a disk shape with a diameter of 95 mm (3.5 inches), and a magnetic recording layer formed on an upper surface (a first surface) and a lower surface (a second surface) of the substrate. The magnetic disks 18 are coaxially fitted to a hub of the spindle motor 19, and are further clamped by a clamp spring 20. Thus, the magnetic disks 18 are supported in parallel to each other and substantially in parallel to the bottom wall 12a at predetermined intervals. The magnetic disks 18 are rotated in a direction of an arrow C at a predetermined rotation speed by the spindle motor 19. Note that the number of magnetic disks 18 to be mounted is not limited to 10, and may be 9 or less, or 10 or more and 12 or less.

In the housing 10, there are provided a plurality of magnetic heads 17 that record and read information on and from the magnetic disk 18, and an actuator assembly 22 that movably supports the magnetic heads 17 with respect to the magnetic disk 18. Further, in the housing 10, there are provided a voice coil motor (VCM) 24 that rotates and positions the actuator assembly 22, a ramp load mechanism 25 that holds the magnetic heads 17 at an unload position separated from the magnetic disks 18 when the magnetic heads 17 move to an outermost periphery of the magnetic disk 18, a substrate unit (an FPC unit) 21 on which electronic components such as a conversion connector are mounted, and a spoiler 70. The VCM 24 includes a pair of yokes 35 provided on the bottom wall 12a and a magnet (not illustrated) fixed to the yoke 35. The ramp load mechanism 25 includes a ramp 74 erected on the bottom wall 12a.

A printed circuit board 27 is screwed to an outer surface of the bottom wall 12a of the base 12. The printed circuit board 27 constitutes a control unit that controls an operation of the spindle motor 19 and controls operations of the VCM 24 and the magnetic heads 17 via the substrate unit 21.

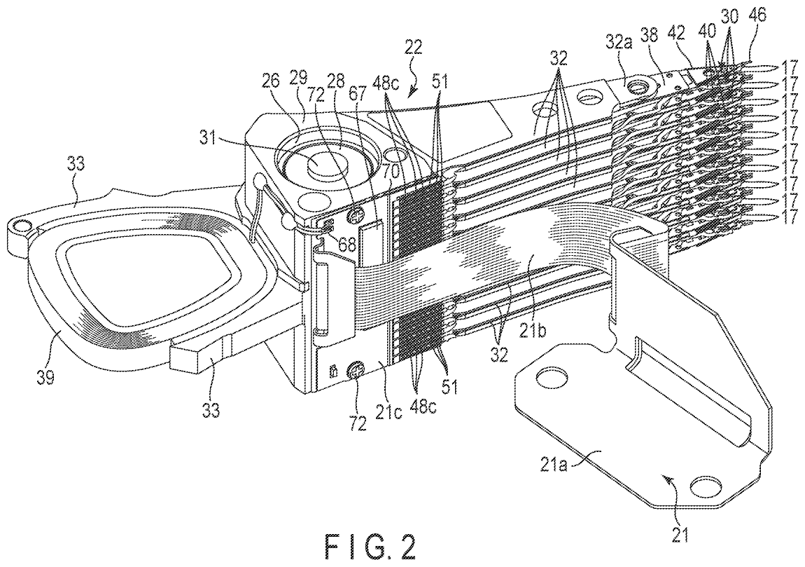

FIG. 2 is a perspective view illustrating the actuator assembly. As illustrated, the actuator assembly 22 comprises an actuator block 29 having a through-hole 26, a bearing unit (unit bearing) 28 provided in the through-hole 26, a plurality of, for example, eleven arms 32 extending from the actuator block 29, a suspension assembly (may be referred to as head gimbal assembly: HGA) 30 attached to each arm 32, and the magnetic head 17 supported by the suspension assembly 30. A support shaft (pivot) 31 is erected on the bottom wall 12a of the base 12. The actuator block 29 is rotatably supported around the support shaft 31 by the bearing unit 28.

In the present embodiment, the actuator block 29 and the eleven arms 32 are integrally formed of aluminum or the like to constitute a so-called E block. The arm 32 is formed in, for example, an elongated flat plate shape, and extends from the actuator block 29 in a direction perpendicular to the support shaft 31. The eleven arms 32 are provided in parallel with a gap from each other.

The actuator assembly 22 comprises a support frame 33 extending from the actuator block 29 in a direction opposite to the arm 32, and a voice coil 39 constituting a part of the VCM 24 is supported by the support frame 33. As illustrated in FIG. 1, the voice coil 39 is positioned between the pair of yokes 35 one of which is fixed on the base 12, and constitutes the VCM 24 together with the yokes 35 and the magnet fixed to any one of the yokes.

As illustrated in FIG. 2, the actuator assembly 22 comprises twenty head suspension assemblies 30 each supporting the magnetic head 17. The head suspension assembly 30 is attached to an extending end 32a of each arm 32. The head suspension assemblies 30 include an up-head suspension assembly that supports the magnetic head 17 upward and a down-head suspension assembly that supports the magnetic head 17 downward. The up-head suspension assembly and the down-head suspension assembly are formed by arranging the head suspension assemblies 30 having the same structure in different vertical directions.

In the present embodiment, in FIG. 2, the down-head suspension assembly 30 is attached to the uppermost arm 32, and the up-head suspension assembly 30 is attached to the lowermost arm 32. The up-head suspension assembly 30 and the down-head suspension assembly 30 are attached to each of intermediate nine arms 32.

The head suspension assembly 30 comprises a substantially rectangular base plate 38, a load beam 42 made of an elongated leaf spring, and an elongated strip-shaped flexure (wiring member) 40. The flexure 40 has a gimbal portion to be described later, and the magnetic head 17 is placed on the gimbal portion. A base end portion of the base plate 38 is fixed to the extending end 32a of the arm 32, and is crimped, for example. A base end portion of the load beam 42 is overlapped on and fixed to an end portion of the base plate 38. The load beam 42 extends from the base plate 38 and is formed to be tapered toward the extending end. The base plate 38 and the load beam 42 are made of stainless steel, for example.

The load beam 42 generates a spring force (reaction force) to urge the magnetic head 17 toward a surface of the magnetic disk 18. Further, a tab 46 protrudes from a tip of the load beam 42. The tab 46 is engageable with the ramp 74 described above, and constitutes the ramp load mechanism 25 together with the ramp 74.

As illustrated in FIG. 2, the FPC unit 21 integrally includes a substantially rectangular base portion 21a bent in an L shape, an elongated strip-shaped relay portion 21b extending from a side edge of the base portion 21a, and a joint portion 21c continuously provided at a tip of the relay portion 21b. The base portion 21a, the relay portion 21b, and the joint portion 21c are formed of a flexible printed circuit board (FPC). The flexible printed circuit board includes an insulating layer of polyimide or the like, a conductive layer formed on the insulating layer and having a plurality of wires, connection pads, and the like formed thereon, and a protective layer covering the conductive layer.

Electronic components such as a conversion connector and a plurality of capacitors (not illustrated) are mounted on the base portion 21a, and are electrically connected to the wires (not illustrated). A metal plate functioning as a reinforcing plate is attached to the base portion 21a. The base portion 21a is provided on the bottom wall 12a of the base 12. The relay portion 21b extends from the side edge of the base portion 21a toward the actuator block 29 of the actuator assembly 22. The joint portion 21c provided at an extending end of the relay portion 21b is formed in a rectangular shape having substantially the same height and width as a side surface (an installation surface) of the actuator block 29. The joint portion 21c is attached to the installation surface of the actuator block 29 via a backing plate made of aluminum or the like, and is further screwed and fixed to the installation surface by a fixing screw 72. A large number of connection pads are provided in the joint portion 21c. For example, a head IC (head amplifier) 67 is mounted on the joint portion 21c, and the head IC 67 is connected to the connection pad and the base portion 21a via the wires. Further, a connection terminal 68 to which the voice coil 39 is connected is provided in the joint portion 21c.

The flexure 40 of each head suspension assembly 30 includes an end portion electrically connected to the magnetic head 17, the other end portion extending to the actuator block 29 through a groove formed in a side edge of the arm 32, and a connection end portion (tail connection terminal portion) 48c provided at the other end portion. The connection end portion 48c is formed in an elongated rectangular shape. A plurality of, for example, thirteen connection terminals (connection pads) 51 are provided at the connection end portion 48c. The connection terminals 51 are respectively connected to the wires of the flexures 40. That is, the wires of the flexures 40 extend over substantially the entire length of the flexures 40, and an end is electrically connected to the magnetic head 17 and the other end is connected to the connection terminal (connection pad) 51.

The connection terminals 51 provided at connection end portions 48c of twenty flexures 40 are bonded to the connection pads of the joint portion 21c and are electrically connected to the wires of the joint portion 21c via the connection pads. Thus, twenty magnetic heads 17 of the actuator assembly 22 are electrically connected to the base portion 21a through the wires of the flexures 40, the connection end portions 48c, the joint portion 21c of the FPC unit 21, and the relay portion 21b.

In a state where the actuator assembly 22 configured as described above is assembled on the base 12, the support shaft 31 is erected substantially parallel to a spindle of the spindle motor 19. Each magnetic disk 18 is located between two head suspension assemblies 30. During operation of the HDD, the magnetic head 17 supported by the two head suspension assemblies 30 faces an upper surface and a lower surface of the magnetic disk 18.

Next, a configuration of the head suspension assembly 30 will be described in detail.

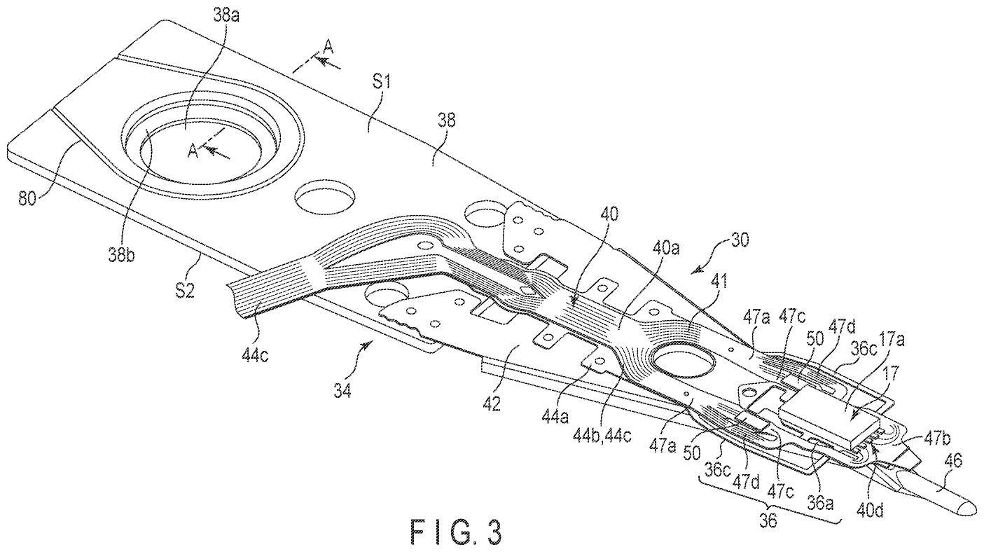

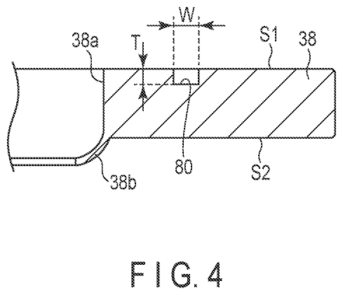

FIG. 3 is a perspective view illustrating a side of the magnetic head of the head suspension assembly, and FIG. 4 is a partial sectional view of the base plate taken along line A-A of FIG. 3.

As illustrated in FIG. 3, the head suspension assembly 30 includes a suspension 34 functioning as a support plate. The suspension 34 has a rectangular base plate 38 made of a metal plate having a thickness of several hundred microns and an elongated leaf spring-like load beam 42 made of a metal plate having a thickness of several tens of microns. In an example, the plate thickness of the base plate 38 is formed to be about 150 to 200 μm, and the plate thickness of the load beam 42 is formed to be about 25 to 30 μm. The base plate 38 has a substantially rectangular first main surface S1 and a substantially rectangular second main surface S2 facing each other. The base plate 38 has a pair of side edges facing each other, and an end edge on the base end side and the other end edge on the tip side, which intersect the side edges. When the head suspension assembly 30 is incorporated in the HDD, the first main surface S1 of the base plate 38 faces the magnetic disk 18.

The base end portion of the load beam 42 is disposed to overlap a tip portion on the first main surface S1 side of the base plate 38, and is fixed to the base plate 38 by welding a plurality of portions. The load beam 42 extends from the base plate 38. A width of the base end portion of the load beam 42 is formed substantially equal to that of the base plate 38. The load beam 42 is formed to be tapered, that is, the width gradually decreases from the base end portion toward the tip portion. An elongated rod-shaped tab 46 protrudes from the tip of the load beam 42.

The base plate 38 has a circular through-hole (crimping hole) 38a formed at the base end portion thereof and an annular flange portion 38b positioned around the through-hole 38a. The flange portion 38b extends into the through-hole 38a and protrudes toward the second main surface S2.

A partition recess 80 is formed on the first main surface S1 of the base plate 38 between the through-hole 38a and the magnetic head 17. In the present embodiment, the partition recess 80 is formed by a continuous groove. The partition recess 80 extends from a portion of the end edge on the base end side of the base plate 38 toward the through-hole 38a side, extends in an arc shape so as to surround the through-hole 38a, and further extends to another portion of the end edge.

As described later, the partition recess 80 is a recess for storing excess liquid lubricant transferred from a metal ball to a hole inner wall of the through-hole 38a during a crimping process. The partition recess 80 has a volume (groove volume) of 0.005 mm³ or more. As illustrated in FIG. 4, the partition recess 80 has, for example, a substantially rectangular sectional shape. In an example, the partition recess (continuous groove) 80 has a depth T of 30 μm and a width W of 50 μm. In this case, the length of the partition recess 80 is only required to be 4 mm or more.

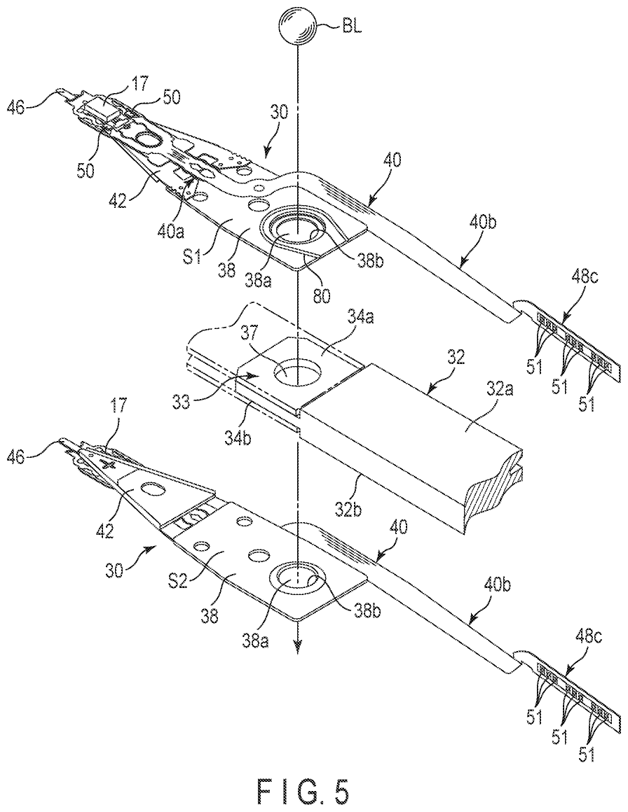

As illustrated in FIG. 3, the head suspension assembly 30 includes a pair of piezoelectric elements (PZT elements) 50, and the elongated strip-shaped flexure (wiring member) 40 for transmitting a recording and reading signal and a drive signal of the piezoelectric elements 50. In the flexure 40, a tip side portion 40a is attached on the load beam 42 and the base plate 38, and a rear half portion (extending portion) 40b extends outward from the side edge of the base plate 38 and extends along the side edge of the arm 32 (see FIG. 5). Then, the connection end portion 48c located at the tip of the extending portion 40b is connected to the joint portion 21c of the FPC unit 21 described above.

The tip portion of the flexure 40 located on the tip portion of the load beam 42 constitutes a gimbal portion 36 functioning as an elastic support portion. The magnetic head 17 is placed and fixed on the gimbal portion 36, and is supported by the load beam 42 via the gimbal portion 36. The pair of piezoelectric elements 50 as drive elements are attached to the gimbal portion 36 and is located on the base end side of the load beam 42 with respect to the magnetic head 17.

The flexure 40 includes a metal thin plate (metal plate) 44a made of stainless steel or the like as a base and a strip-shaped laminated member 41 attached or fixed onto the metal thin plate 44a, and forms an elongated laminated plate. The laminated member 41 includes a base insulating layer 44b mostly fixed to the metal thin plate 44a, a conductive layer (wiring pattern) 44c formed on the base insulating layer 44b and constituting a plurality of signal wires and drive wires, and a cover insulating layer covering the conductive layer 44c and laminated on the base insulating layer 44b. In the tip side portion 40a of the flexure 40, the metal thin plate 44a side is attached onto surfaces of the load beam 42 and the base plate 38, or spot-welded at a plurality of welding points.

In the gimbal portion 36, the metal thin plate 44a has a rectangular tongue portion (support portion) 36a located on the tip side, and a pair of elongated outriggers (link portions) 36c extending from the tongue portion 36a to the base end portion. The tongue portion 36a is formed in a size and a shape on which the magnetic head 17 can be placed, and is formed in, for example, a substantially rectangular shape. The tongue portion 36a is disposed such that a central axis in a width direction of the tongue portion 36a coincides with a central axis of the suspension 34. Further, a substantially central portion of the tongue portion 36a contacts a dimple (protrusion) (not illustrated) protruding from the tip portion of the load beam 42. The tongue portion 36a can be displaced in various directions with the dimple as a fulcrum by the pair of outriggers 36c being elastically deformed. Thus, the tongue portion 36a and the magnetic head 17 mounted on the tongue portion 36a can flexibly follow surface variation of the magnetic disk 18 in roll and pitch directions, and maintain a minute gap between the surface of the magnetic disk 18 and the magnetic head 17.

In the gimbal portion 36, a part of the laminated member 41 is bifurcated and located on both sides of the central axis of the suspension 34. The laminated member 41 includes a pair of base end portions 47a fixed to the metal thin plate 44a, a tip portion 47b attached onto the tongue portion 36a, a pair of strip-shaped first bridge portions 47c extending from the base end portion 47a to the tip portion 47b, and a pair of strip-shaped second bridge portions (branch portions) 47d extending from the base end portion 47a to a middle portion of the first bridge portion 47c side by side with the first bridge portion 47c and joining the first bridge portion 47c. The first bridge portion 47c constitutes a mounting portion on which the piezoelectric element 50 is mounted.

The magnetic head 17 has a substantially rectangular slider 17a, and the slider 17a is fixed to the tongue portion 36a with an adhesive. The magnetic head 17 is disposed such that a central axis in a longitudinal direction thereof coincides with the central axis of the suspension 34, and a substantially central portion of the magnetic head 17 is located on the dimple. A recording and reading element of the magnetic head 17 is electrically bonded to a plurality of electrode pads 40d of the tip portion 47b with a conductive adhesive such as solder or silver paste. Thus, the magnetic head 17 is connected to the signal wire of the flexure 40 via the electrode pad 40d.

As the pair of piezoelectric elements 50, for example, rectangular plate-shaped thin film piezoelectric elements (PZT elements) are used. Each of the piezoelectric elements 50 is attached to an upper surface of the first bridge portion 47c with the adhesive or the like. Each piezoelectric element 50 is electrically connected to the drive wire for transmitting the drive signal. The piezoelectric element 50 is disposed such that its longitudinal direction (expansion and contraction direction) is parallel to a longitudinal direction of the load beam 42 and the first bridge portion 47c. The two piezoelectric elements 50 are arranged side by side in parallel to each other, and are arranged on both sides of the magnetic head 17 so as to be shifted from the magnetic head 17 toward the base end portion 47a side of the laminated member 41. Note that the piezoelectric element 50 may be disposed to be inclined with respect to the longitudinal direction of the first bridge portion 47c, and for example, the two piezoelectric elements 50 may be arranged in a chevron shape.

FIG. 5 is an exploded perspective view illustrating the up-head suspension assembly, the arm, and the down-head suspension assembly.

As illustrated in the figure, the head suspension assembly 30 configured as described above is attached to an extending end portion of the arm 32. A thin crimping portion (fixing portion) 33 is formed at the extending end (tip portion) of the arm 32. The fixing portion 33 has a first installation surface 34a that is one step lower than a first main surface 32a of the arm 32 and a second installation surface 34b that is one step lower than a second main surface 32b of the arm 32. The second installation surface 34b faces the first installation surface 34a in parallel. The fixing portion 33 has a circular crimping hole 37 formed through the first installation surface 34a and the second installation surface 34b. In an example, the plate thickness of the arm 32 is set to about 0.78 mm, and the thickness of the fixing portion 33 is set to about 0.5 mm.

Each head suspension assembly 30 is disposed such that the second main surface S2 of the base plate 38 faces the fixing portion 33. The base end portion of the base plate 38 is placed on the first installation surface 34a or the second installation surface 34b of the fixing portion 33, and the flange portion 38b is fitted into the crimping hole 37 of the fixing portion 33. In this state, a metal ball BL for crimping is pushed into the through-hole 38a of the base plate 38. Since the diameter of the metal ball BL is set to be larger than the inner diameter of the flange portion 38b, the flange portion 38b is pressed toward an inner wall surface of the crimping hole 37 and plastically deformed according to push-in of the metal ball BL. By plastic deformation (crimping) of the flange portion 38b, the base plate 38 is fastened to the crimping hole 37 of the arm 32 with a sufficient fastening force, and is fixed to the fixing portion 33.

Note that the first and second installation surfaces 34a and 34b of the fixing portion 33 may be respectively formed flush with the first main surface 32a and the second main surface 32b of the arm 32.

According to the HDD and the head suspension assembly 30 according to the first embodiment configured as described above, the partition recess 80 is provided on the first main surface S1 of the base plate 38 so as to partition the through-hole 38a and the magnetic head 17 and surround the through-hole 38a. The liquid lubricant such as perfluoropolyether of about 2 to 3 nm is applied to the metal ball BL used for crimping the base plate 38, and the excess liquid lubricant may be transferred from the metal ball BL to the inner wall of the crimping hole during crimping. The transferred excess liquid lubricant flows along the first main surface S1 of the base plate 38 during a seek operation of the magnetic head, but the lubricant that has reached the partition recess 80 is held in the partition recess 80, and diffusion toward the load beam 42 and the magnetic head 17 is prevented. In an example, when the volume (groove volume) of the partition recess 80 is 0.005 mm³ or more as determined from an amount of the excessive lubricant that may fall on a magnetic recording medium, all the excessive lubricant can be stored in the recess 80, and the diffusion toward the load beam 42 and the magnetic head 17 can be suppressed.

As described above, the HDD and the head suspension assembly according to the present embodiment can suppress the diffusion of the excess lubricant and fall of the excess lubricant to the magnetic disk, prevent the magnetic disk from being contaminated by the excess lubricant, and maintain stable floating of the magnetic head. Thus, according to the present embodiment, it is possible to provide the HDD and the head suspension assembly having improved reliability.

Note that in the first embodiment, the shape and dimension of the partition recess 80 are not limited to the above embodiment, and can be variously modified as necessary. The sectional shape of the partition recess 80 is not limited to a rectangular shape, and a semicircular shape, a triangular shape, and various other shapes can be applied.

Next, the head suspension assembly of the HDD according to other embodiments will be described. In other embodiments described below, the same parts as those of the first embodiment described above are denoted by the same reference numerals, detailed description thereof will be omitted or simplified, and portions different from those of the first embodiment will be mainly described in detail.

### Second Embodiment

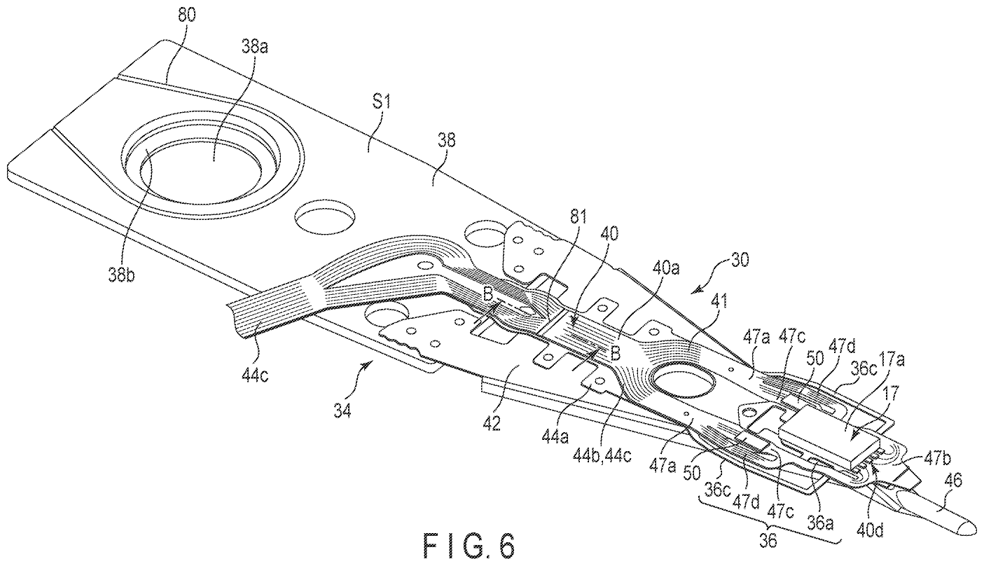

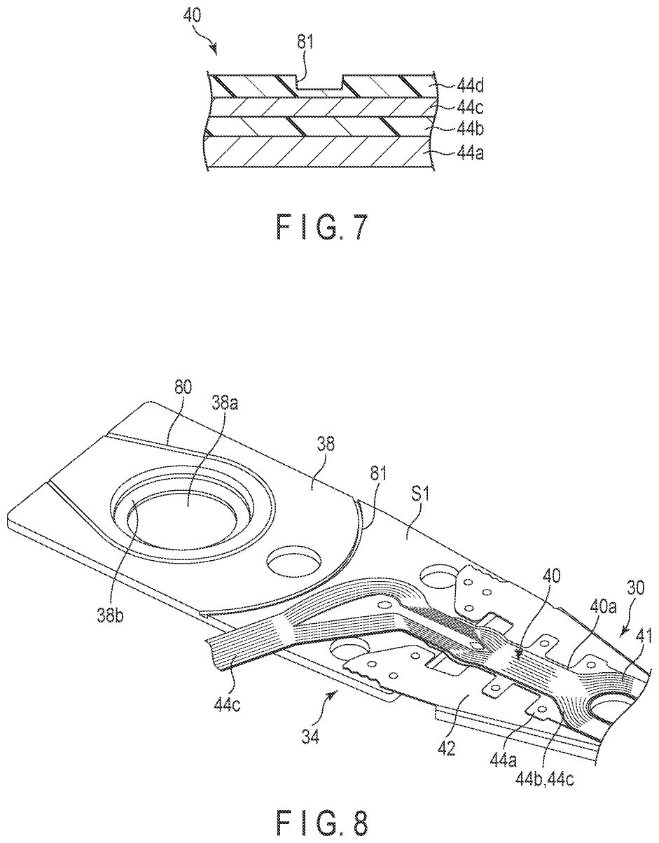

FIG. 6 is a perspective view illustrating a head suspension assembly of an HDD according to a second embodiment, and FIG. 7 is a sectional view of the flexure taken along line B-B of FIG. 6.

As illustrated in FIG. 6, according to the second embodiment, a head suspension assembly 30 further includes a second recess 81 formed in a flexure 40 in addition to a partition recess 80 provided in a base plate 38. The second recess 81 is provided between a through-hole 38a of the base plate 38 and a magnetic head 17 in the flexure 40. In the present embodiment, the second recess 81 is made of a continuous groove extending perpendicular to a longitudinal direction of the flexure 40, extends from one side edge to the other side edge of the flexure 40, and divides the through-hole 38a from the magnetic head 17.

As illustrated in FIG. 7, the flexure 40 includes a metal thin plate (metal plate) 44a such as stainless steel as the base, a base insulating layer 44b attached or fixed onto the metal thin plate 44a, a conductive layer (wiring pattern) 44c formed on the base insulating layer 44b and constituting signal wires and drive wires, and a cover insulating layer 44d covering the conductive layer 44c and laminated on the base insulating layer 44b. The cover insulating layer 44d is formed of, for example, an insulating material such as polyimide.

The second recess 81 is formed in the cover insulating layer 44d. In an example, a part of the cover insulating layer 44d is thinned by etching to form the second recess 81. In consideration of manufacturability, the depth of the second recess 81 formed by etching is about 10 μm and the width thereof is about 20 μm while the thickness of the cover insulating layer is 20 μm.

According to the second embodiment having the above configuration, the excess lubricant is stored or held in the partition recess 80 provided in the base plate 38, and the diffusion toward the magnetic head 17 side is prevented. Furthermore, even if the excess lubricant is transferred to the flexure 40, the excess lubricant flows into the second recess 81 and is held in the second recess 81, and the diffusion toward the magnetic head 17 side is prevented.

As described above, according to the second embodiment, it is possible to more reliably suppress the diffusion of the excess lubricant and the fall of the excess lubricant to the magnetic disk, and to provide the HDD and the head suspension assembly having improved reliability.

Note that in the second embodiment, the number of the second recesses 81 is not limited to one, and two or more second recesses may be provided side by side.

### Third Embodiment

FIG. 8 is a perspective view illustrating a head suspension assembly of an HDD according to a third embodiment.

As illustrated in the figure, according to the third embodiment, a head suspension assembly 30 further includes a second recess 81 formed in a first main surface S1 of a base plate 38 similarly to a partition recess 80 in addition to the partition recess 80 provided in the base plate 38. The second recess 81 is provided to divide a through-hole 38a from a magnetic head 17 in the base plate 38. In the present embodiment, the second recess 81 is made of a continuously extending arcuate groove, extends from one side edge to the other side edge of the base plate 38, and divides the partition recess 80 from the magnetic head 17. The depth and width of the second recess 81 are substantially the same as those of the partition recess 80.

According to the third embodiment having the above configuration, the excess lubricant is stored or held in the partition recess 80 provided in the base plate 38, and the diffusion toward the magnetic head 17 side is prevented. Furthermore, even if the excess lubricant is transferred to the first main surface S1 of the base plate 38 beyond the partition recess 80, the excess lubricant flows into the second recess 81 and is held in the second recess 81, and the diffusion toward the magnetic head 17 side is prevented.

As described above, according to the third embodiment, it is possible to more reliably suppress the diffusion of the excess lubricant and the fall of the excess lubricant to the magnetic disk, and to provide the HDD and the head suspension assembly having improved reliability.

Note that in the third embodiment, the number of the second recesses 81 is not limited to one, and two or more second recesses may be provided side by side.

### Fourth Embodiment

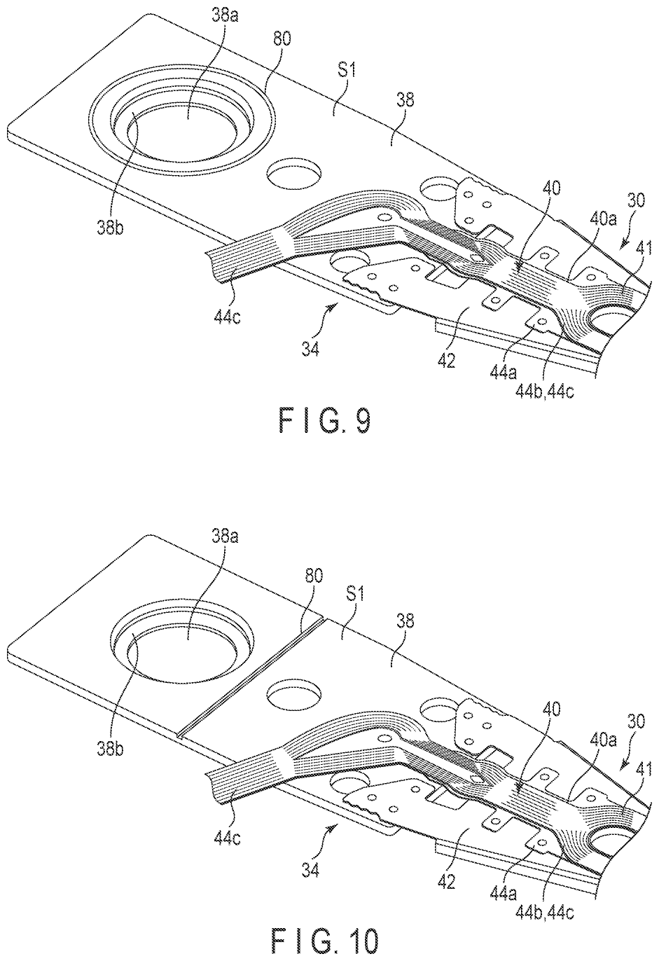

FIG. 9 is a perspective view illustrating a head suspension assembly of an HDD according to a fourth embodiment.

As illustrated in the figure, according to the fourth embodiment, a partition recess 80 of a base plate 38 is made of a continuously extending annular groove. The partition recess 80 is provided to surround a through-hole 38a, and divides the through-hole 38a from a magnetic head. The partition recess 80 has an inner diameter larger than the diameter of the through-hole 38a, and is provided outside the through-hole 38a with a gap.

Note that a part or all of the partition recess 80 may be positioned to overlap a peripheral edge of the through-hole 38a.

Also in the fourth embodiment having the above configuration, it is possible to obtain the same operation and effect as those of the first embodiment described above.

### Fifth Embodiment

FIG. 10 is a perspective view illustrating a head suspension assembly of an HDD according to a fifth embodiment.

As illustrated in the figure, according to the fifth embodiment, a partition recess 80 of a base plate 38 is made of a continuously extending linear groove. The partition recess 80 is provided to partition a through-hole 38a and a magnetic head 17 in a first main surface S1 of base plate 38. In the present embodiment, the partition recess 80 extends from one side edge to the other side edge of the base plate 38, and extends in a direction perpendicular to a longitudinal direction of the base plate 38. The partition recess 80 has a volume (groove volume) of 0.005 mm³ or more.

Also in the fifth embodiment having the above configuration, it is possible to obtain the same operation and effect as those of the first embodiment described above.

Note that in the fifth embodiment, the partition recess 80 may extend in a direction inclined with respect to the direction perpendicular to the longitudinal direction of the base plate 38. Further, the partition recess 80 is not limited to a linear shape, and may have a shape bent at one or a plurality of positions or a curved shape. Further, the number of partition recesses 80 is not limited to one, and two or more partition recesses may be provided.

### Sixth Embodiment

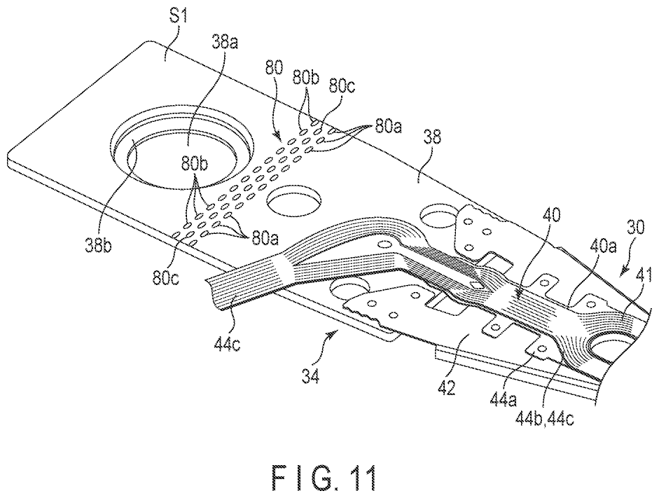

FIG. 11 is a perspective view illustrating a head suspension assembly of an HDD according to a sixth embodiment.

A partition recess 80 of a base plate 38 is not limited to a recess made of a continuous groove, and may be made of a plurality of recesses arranged intermittently. As illustrated in FIG. 11, according to the sixth embodiment, the partition recess 80 of the base plate 38 includes a row of recesses formed by intermittently arranging a plurality of dot-like recesses. The row of recesses may be a row, but in the present embodiment, the partition recess 80 includes three rows of recesses 80a, 80b, and 80c.

In an example, each row of recesses includes 50 dot-like recesses 80a (80b, 80c) each having a diameter of 80 μm and a depth of 30 μm, which are arranged intermittently and linearly. The partition recess 80 is provided to partition the through-hole 38a and a magnetic head 17. In the present embodiment, each row of recesses 80a, 80b, and 80c extends from one side edge to the other side edge of the base plate 38, and extends in the direction perpendicular to the longitudinal direction of the base plate 38. The three rows of recesses 80a, 80b, and 80c are provided side by side in the longitudinal direction. The partition recess 80 including a large number of recesses 80a, 80b, and 80c is formed to have a volume (groove volume) of 0.005 mm³ or more.

Also in the sixth embodiment having the above configuration, it is possible to obtain the same operation and effect as those of the first embodiment described above.

Note that in the sixth embodiment, the partition recess 80 may extend in the direction inclined with respect to the direction perpendicular to the longitudinal direction of the base plate 38. Further, the partition recess 80 is not limited to a linear shape, and may have a shape bent at one or a plurality of positions or a curved shape. Further, the number of rows of recesses of constituting the partition recess 80 is not limited to three, and one, two, or four or more may be provided.

The partition recess formed by intermittently arranging the recesses may be applied to the partition recess 80 and/or a second recess 81 in the first to fifth embodiments described above.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of installed magnetic disks is not limited to 10, and can be increased to 11 or 12.

What is claimed is:

1. A head suspension assembly comprising:
a base plate including a first main surface and a through-hole penetrating the first main surface;
a load beam including a base end portion fixed to the base plate and extending from the base plate;
a wiring member provided on the first main surface of the base plate and the load beam, and including a gimbal portion facing an extending end portion of the load beam; and
a magnetic head placed on the gimbal portion,
wherein the base plate includes a partition recess formed on the first main surface and continuously or intermittently extending to partition the magnetic head and the through-hole.

2. The head suspension assembly of claim 1, wherein
the base plate includes a pair of side edges facing each other and an end edge intersecting the pair of side edges,
the through-hole is located between the pair of side edges on a side of the end edge, and
the partition recess extends from a part of the end edge, surrounds the through-hole, and extends to another part of the end edge.

3. The head suspension assembly of claim 1, wherein
the base plate includes a pair of side edges facing each other and an end edge intersecting the pair of side edges,
the through-hole is located between the pair of side edges on a side of the end edge, and
the partition recess annularly extends to surround the through-hole.

4. The head suspension assembly of claim 1, wherein
the base plate includes a pair of side edges facing each other and an end edge intersecting the pair of side edges,
the through-hole is located between the pair of side edges on a side of the end edge, and
the partition recess extends from one of the side edges to the other of the side edges.

5. The head suspension assembly of claim 1, wherein
the base plate includes a second recess formed on the first main surface and extending to partition the partition recess and the magnetic head.

6. The head suspension assembly of claim 1, wherein
the wiring member includes a second recess extending to partition the through-hole and the magnetic head.

7. The head suspension assembly of claim 1, wherein
the partition recess is formed of a continuous groove.

8. The head suspension assembly of claim 5, wherein
at least one of the partition recess and the second recess is formed of a plurality of recesses which are intermittently arranged.

9. The head suspension assembly of claim 6, wherein
at least one of the partition recess and the second recess is formed of a plurality of recesses which are intermittently arranged.

10. A magnetic disk device comprising:
a rotatable magnetic disk; and
an actuator assembly including an arm and the head suspension assembly of claim 1 attached to the arm.

11. The magnetic disk device of claim 10, wherein
the base plate includes a pair of side edges facing each other and an end edge intersecting the pair of side edges,
the through-hole is located between the pair of side edges on a side of the end edge, and
the partition recess extends from a part of the end edge, surrounds the through-hole, and extends to another part of the end edge.

12. The magnetic disk device of claim 10, wherein
the base plate includes a pair of side edges facing each other and an end edge intersecting the pair of side edges,
the through-hole is located between the pair of side edges on a side of the end edge, and
the partition recess annularly extends to surround the through-hole.

13. The magnetic disk device of claim 10, wherein
the base plate includes a pair of side edges facing each other and an end edge intersecting the pair of side edges,
the through-hole is located between the pair of side edges on a side of the end edge, and
the partition recess extends from one of the side edges to the other of the side edges.
